(19) United States
(12) Patent Application Publication
(10) Pub. No.: US 2024/0319319 A1
(43) Pub. Date: Sep. 26, 2024

(54) HYBRID TRANSMISSION AND RECEPTION SCHEME FOR INTEGRATED SENSING AND COMMUNICATION

(71) Applicant: ZTE CORPORATION, Shenzhen (CN)

(72) Inventors: Yihua MA, Shenzhen (CN); Zhifeng YUAN, Shenzhen (CN); Shuqiang XIA, Shenzhen (CN); Guanghui YU, Shenzhen (CN); Liujun HU, Shenzhen (CN)

(73) Assignee: ZTE CORPORATION, Shenzhen (CN)

(21) Appl. No.: 18/678,035

(22) Filed: May 30, 2024

Related U.S. Application Data
(63) Continuation of application No. PCT/CN2022/083241, filed on Mar. 28, 2022.

(51) Int. Cl. G01S 7/00; G01S 13/00; H04L 5/00; H04L 5/16

(52) U.S. Cl. CPC G01S 7/006; G01S 13/003; H04L 5/0007; H04L 5/16

(57) ABSTRACT

A wireless communication and sensing method comprising: performing, by a wireless communication and sensing node, a communication function of an integrated sensing and communication, ISAC, signal via one or more communication antennas; and performing, by the wireless communication and sensing node, a sensing function of the ISAC signal via the one or more communication antennas and one or more sensing-dedicated antennas.

### CROSS-REFERENCE TO RELATED PATENT APPLICATIONS

This application is a Continuation of PCT Application No. PCT/CN2022/083241, filed Mar. 28, 2022, incorporated herein by reference in its entirety.

### TECHNICAL FIELD

This document is directed generally to wireless communications, and in particular to 6^{th} generation (6G) communications.

### BACKGROUND

Integrated sensing and communication (ISAC) is expected to provide enormous add-on values to the communication systems in the 6G era. One major challenge of adopting ISAC is how to cancel self-interference (e.g., in monostatic sensing scenario).

### SUMMARY

The full-duplex communications system is very complex and expensive, while sensing or radar has a simpler way to deal with the self-interference as the sensing signal can be specifically designed.

The sensing signal in the existing ISAC schemes may use Orthogonal Frequency-Division Multiplexing (OFDM) signal or Frequency-Modulated Continuous-Wave (FMCW) signal.

When the OFDM signal is used for sensing, it is possible to reuse the communication signal to avoid sensing overheads. However, it requires complex full-duplex hardware to cancel the self-interference and a sensing beam may be different from a communication beam.

When the full duplex is supported for communications, the sensing function uses the antenna in the same way as the full-duplex communications. When the FMCW signal is used for sensing, the self-interference cancellation may be simpler. However, a separated dual-function implementation requires dedicated antennas for sensing and communications.

In order to overcome the above problems, the present disclosure proposes an ISAC scheme where the communications sub-system is half-duplex and has the same antenna for transmitting and receiving, while the sensing sub-system is full-duplex and has different antennas for transmissions and receptions. Moreover, the communications antenna is reused by the sensing sub-system to transmit or receive.

One aspect of the present disclosure relates to a wireless communication and sensing method. In an embodiment, the wireless communication and sensing method comprises: performing, by a wireless communication and sensing node, a communication function of an integrated sensing and communication, ISAC, signal via one or more communication antennas; and performing, by the wireless communication and sensing node, a sensing function of the ISAC signal via the one or more communication antennas and one or more sensing-dedicated antennas.

Another aspect of the present disclosure relates to a wireless communication and sensing node. In an embodiment, the wireless communication and sensing node comprises: one or more communication antennas configured to perform a communication function of an integrated sensing and communication, ISAC, signal and a sensing function of the ISAC signal; and one or more sensing-dedicated antennas configured to perform a sensing function of the ISAC signal.

Another aspect of the present disclosure relates to a wireless communication and sensing method. In an embodiment, the wireless communication and sensing method comprises: transmitting a sensing signal of an integrated sensing and communication, ISAC, signal via a first group of antenna ports, and receiving an echo signal associated with the sensing signal of the ISAC signal via a second group of antenna ports, wherein the first group of antenna ports are different from the second group of antenna ports.

Another aspect of the present disclosure relates to a first wireless communication and sensing node. In an embodiment, the first wireless communication and sensing node comprises first wireless communication and sensing node, comprising: a communication unit, configured to: transmit a sensing signal of an integrated sensing and communication, ISAC, signal via a first group of antenna ports, and receive an echo signal associated with the sensing signal of the ISAC signal via a second group of antenna ports, wherein the first group of antenna ports are different from the second group of antenna ports.

Another aspect of the present disclosure relates to a wireless communication system. In an embodiment, the wireless communication system comprises: a first wireless communication and sensing node, configured to transmit a sensing signal of an integrated sensing and communication, ISAC, signal via a first group of antenna ports, and a second wireless communication and sensing node, configured to receive an echo signal associated with the sensing signal of the ISAC signal via a second group of antenna ports, wherein the first group of antenna ports are different from the second group of antenna ports.

Various embodiments may preferably implement the following features:

Preferably or in some embodiments, a communication signal of the ISAC signal is sent and received by the one or more communication antennas and a sensing signal of the ISAC signal is received by the one or more communication antennas and transmitted by the one or more sensing-dedicated antennas.

Preferably or in some embodiments, a communication signal of the ISAC signal is sent and received by the one or more communication antennas and a sensing signal of the ISAC signal is transmitted by the one or more communication antennas and received by the one or more sensing-dedicated antennas.

Preferably or in some embodiments, the communication function is half-duplex.

Preferably or in some embodiments, the sensing function is full-duplex.

Preferably or in some embodiments, the one or more communication antennas comprises a structure of at least one of a uniform linear array, a uniform two-dimensional array, or an irregular array.

Preferably or in some embodiments, the one or more sensing-dedicated antennas comprise a structure of at least one of a uniform linear array, a uniform two-dimensional array, or an irregular array.

Preferably or in some embodiments, the communication function uses at least one of an orthogonal frequency division Multiplexing, OFDM, waveform or a discrete Fourier transform spread orthogonal frequency division multiplexing, DFT-s-OFDM waveform.

Preferably or in some embodiments, the sensing function uses at least one of a frequency modulated continuous wave, FMCW, signal, an OFDM signal, a pulse signal, a low-correlation sequence signal, or a continuous wave, CW, signal.

Preferably or in some embodiments, the one or more communication antennas are configured to send and receive a communication signal of the ISAC signal and the one or more sensing-dedicated antennas are configured to receive a sensing signal of the ISAC signal.

Preferably or in some embodiments, the first group of antenna ports and the second group of antenna ports are dedicated for the sensing signal.

Preferably or in some embodiments, one of the first group of antenna ports and the second group of antenna ports is configured to perform communications associated with the ISAC signal and another one of the first group of antenna ports and the second group of antenna ports is dedicated for the sensing signal.

Preferably or in some embodiments, the first group of antenna ports and the second group of antenna ports are corresponding to a wireless communication and sensing node.

Preferably or in some embodiments, one of the first group of the antenna ports and the second group of antenna ports is corresponding to a first wireless communication and sensing node and another one of the first group of the antenna ports and the second group of antenna ports is corresponding to a second wireless communication and sensing node different from the first wireless communication and sensing node.

Preferably or in some embodiments, the first wireless communication and sensing node, further comprises a processor configured to perform a wireless communication and sensing method of any one of the described methods.

The present disclosure also relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a wireless terminal according to an embodiment of the present disclosure.

FIG. 2 shows a schematic diagram of a wireless network node according to an embodiment of the present disclosure.

FIG. 3 shows a hybrid ISAC transmission and reception scheme with a sensing-dedicated transmission antenna according to an embodiment of the present disclosure.

FIG. 4 shows another hybrid ISAC transmission and reception scheme with a sensing-dedicated transmission antenna according to an embodiment of the present disclosure.

FIG. 5 shows another hybrid ISAC transmission and reception scheme with a sensing-dedicated transmission antenna according to an embodiment of the present disclosure.

FIG. 6 shows another hybrid ISAC transmission and reception scheme with a sensing-dedicated transmission antenna according to an embodiment of the present disclosure.

FIG. 7 shows a hybrid ISAC transmission and reception scheme with a sensing-dedicated receive antenna according to an embodiment of the present disclosure.

FIG. 8 shows another hybrid ISAC transmission and reception scheme with a sensing-dedicated receive antenna according to an embodiment of the present disclosure.

FIG. 9 shows another hybrid ISAC transmission and reception scheme with a sensing-dedicated receive antenna according to an embodiment of the present disclosure.

FIG. 10 shows another hybrid ISAC transmission and reception scheme with a sensing-dedicated receive antenna according to an embodiment of the present disclosure.

FIG. 11 shows a flowchart of a method according to an embodiment of the present disclosure.

FIG. 12 shows a flowchart of a method according to an embodiment of the present disclosure.

### DETAILED DESCRIPTION

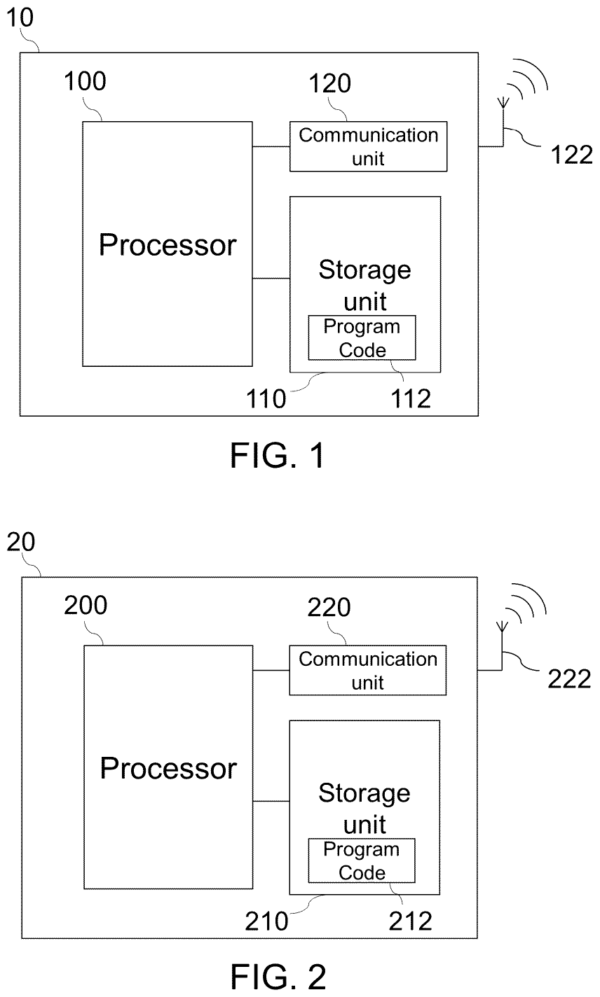

FIG. 1 relates to a schematic diagram of a wireless terminal 10 according to an embodiment of the present disclosure. The wireless terminal 10 may be a user equipment (UE), a mobile phone, a laptop, a tablet computer, an electronic book or a portable computer system and is not limited herein. The wireless terminal 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 112 include but are not limited to a subscriber identity module (SIM), read-only memory (ROM), flash memory, random-access memory (RAM), hard-disk, and optical data storage device. The communication unit 120 may a transceiver and is used to transmit and receive signals (e.g., messages or packets) according to processing results of the processor 100. In an embodiment, the communication unit 120 transmits and receives the signals via at least one antenna 122 shown in FIG. 1.

In an embodiment, the storage unit 110 and the program code 112 may be omitted and the processor 100 may include a storage unit with stored program code.

The processor 100 may implement any one of the steps in exemplified embodiments on the wireless terminal 10, e.g., by executing the program code 112.

The communication unit 120 may be a transceiver. The communication unit 120 may as an alternative or in addition be combining a transmitting unit and a receiving unit configured to transmit and to receive, respectively, signals to and from a wireless network node (e.g., a base station).

FIG. 2 relates to a schematic diagram of a wireless network node 20 according to an embodiment of the present disclosure. The wireless network node 20 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 20 may comprise (perform) at least one network function such as an access and mobility management function (AMF), a session management function (SMF), a user place function (UPF), a policy control function (PCF), an application function (AF), etc. The wireless network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 212 include but are not limited to a SIM, ROM, flash memory, RAM, hard-disk, and optical data storage device. The communication unit 220 may be a transceiver and is used to transmit and receive signals (e.g., messages or packets) according to processing results of the processor 200. In an example, the communication unit 220 transmits and receives the signals via at least one antenna 222 shown in FIG. 2.

In an embodiment, the storage unit 210 and the program code 212 may be omitted. The processor 200 may include a storage unit with stored program code.

The processor 200 may implement any steps described in exemplified embodiments on the wireless network node 20, e.g., via executing the program code 212.

The communication unit 220 may be a transceiver. The communication unit 220 may as an alternative or in addition be combining a transmitting unit and a receiving unit configured to transmit and to receive, respectively, signals to and from a wireless terminal (e.g., a user equipment or another wireless network node).

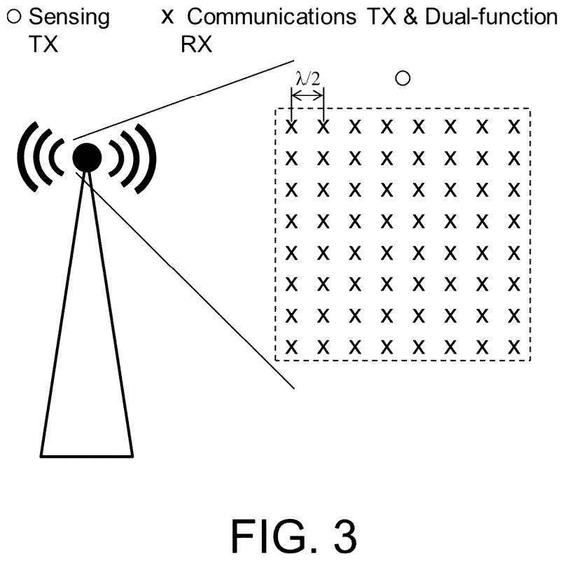

In an embodiment, there is provided a hybrid ISAC transmission and reception scheme with sensing-dedicated transmission antenna as shown in FIG. 3.

This embodiment includes a 64-antenna Multiple-input Multiple-output (MIMO) system plus a single antenna dedicated for sensing. The MIMO system transmits and receives the communications signal and it also receives the sensing signal. Note that the single antenna (i.e., sensing dedicated transmission antenna) is used only for transmitting the sensing signal.

In this embodiment, the communication function is a conventional MIMO system. The sensing function is a Single-input Multiple-output (SIMO) radar. The sensing-dedicated transmission antenna can be omnidirectional or directional.

In an embodiment, the directional sensing transmission antenna may help to limit the self-interference received by the reception antenna. It transmits the sensing signal and the 64-antenna array receives the echo sensing signal.

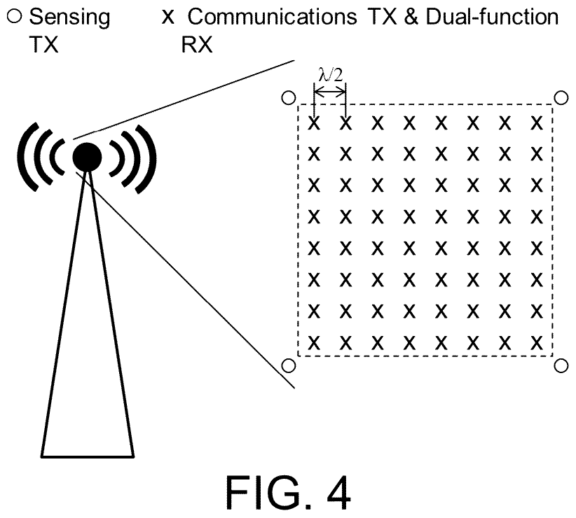

In an embodiment, there is provided another hybrid ISAC transmission and reception scheme with sensing-dedicated transmission antenna as shown in FIG. 4.

This embodiment includes a 64-antenna MIMO system plus four antennas dedicated for sensing. The MIMO system transmits and receives the communications signal and it also receives the sensing signal. Four antennas are used only to transmit the sensing signal.

Using this scheme, the communication function is a conventional MIMO system. The sensing function is a MIMO radar. The sensing-dedicated transmission antenna can be omnidirectional or directional.

In an embodiment, the directional sensing transmission antenna helps to limit the self-interference received by the receive antenna. It transmits the sensing signal and the 64-antenna array receives the echo sensing signal. This MIMO radar can be equivalent to a 256-antenna virtual array which improves the resolution of angle estimation.

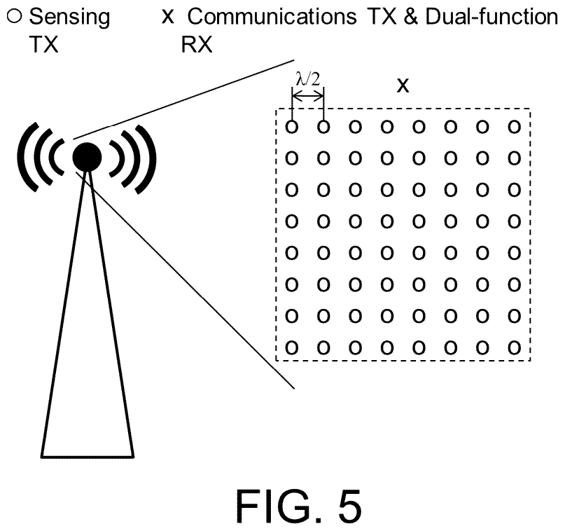

In an embodiment, there is provided another hybrid ISAC transmission and reception scheme with sensing-dedicated transmission antenna as shown in FIG. 5.

This embodiment includes a single-antenna system plus 64-antenna array dedicated for sensing. The single-antenna system transmits and receives the communications signal and it also receives the sensing signal. 64 antennas are used only to transmit the sensing signal.

Using this scheme, the communication function is a conventional single-antenna system. The sensing function is a MISO radar. The sensing-dedicated transmission antenna can be omnidirectional or directional.

In an embodiment, the directional sensing transmission antenna helps to limit the self-interference received by the receive antenna. It transmits the sensing signal and the single antenna receives the echo sensing signal.

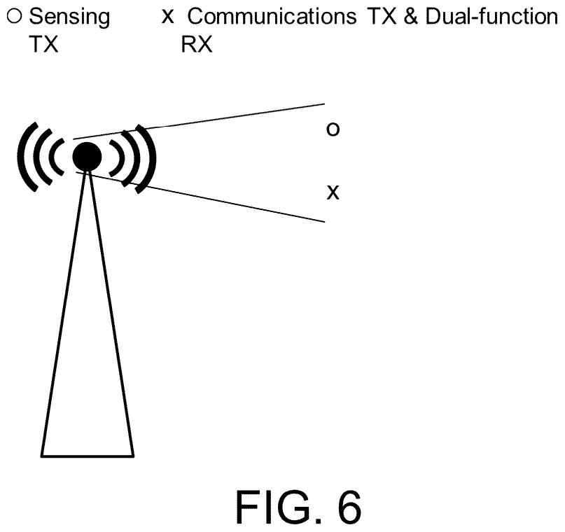

In an embodiment, there is provided another hybrid ISAC transmission and reception scheme with sensing-dedicated transmission antenna as shown in FIG. 6.

This embodiment includes a single-antenna system plus a single antenna dedicated for sensing. The single-antenna system transmits and receives the communications signal and it also receives the sensing signal. The sensing-dedicated antenna is used only to transmit the sensing signal.

Using this scheme, the communication function is a conventional single-antenna system. The sensing function is a SISO radar. The sensing-dedicated transmission antenna can be omnidirectional or directional.

In an embodiment, the directional sensing transmission antenna helps to limit the self-interference received by the receive antenna. It transmits the sensing signal and the dual-function receive antenna receives the echo sensing signal.

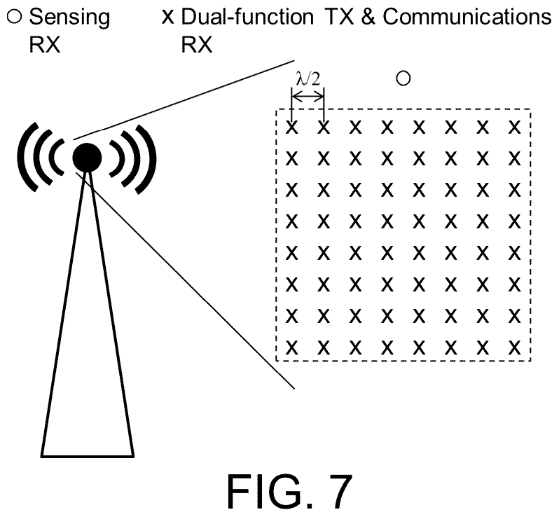

In an embodiment, there is provided another hybrid ISAC transmission and reception scheme with sensing-dedicated receive antenna as shown in FIG. 7.

This embodiment includes a 64-antenna MIMO system plus a single antenna dedicated for sensing. The MIMO system transmits and receives the communications signal and it also transmits the sensing signal. A single antenna is used only to receive the sensing signal.

Using this scheme, the communication function is a conventional MIMO system. The sensing function is a MISO radar. The sensing-dedicated receive antenna can be omnidirectional or directional.

In an embodiment, the directional sensing receive antenna helps to limit the self-interference sent by the transmission antenna. The 64-antenna array transmits the sensing signal and the single antenna receives the echo sensing signal.

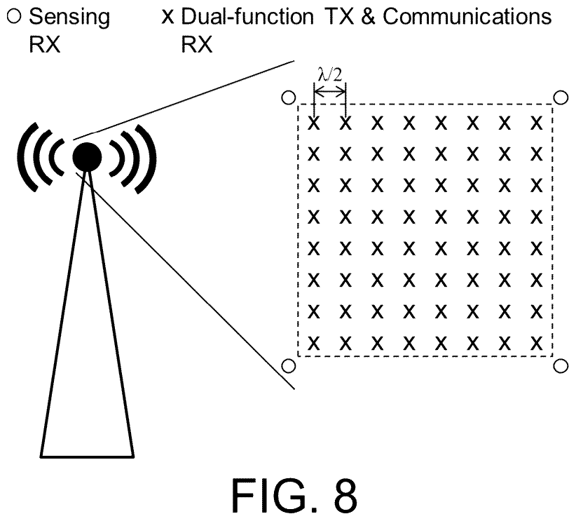

In an embodiment, there is provided another hybrid ISAC transmission and reception scheme with sensing-dedicated receive antenna as shown in FIG. 8.

This embodiment includes a 64-antenna MIMO system plus four antennas dedicated for sensing. The MIMO system transmits and receives the communications signal and it also transmits the sensing signal. Four antennas are used only to receive the sensing signal.

Using this scheme, the communication function is a conventional MIMO system. The sensing function is a MIMO radar. The sensing-dedicated receive antenna can be omnidirectional or directional.

In an embodiment, the directional sensing receive antenna helps to limit the self-interference sent by the transmission antenna. The 64-antenna array transmits the sensing signal and four antennas receive the echo sensing signal. This MIMO radar can be equivalent to a 256-antenna virtual array which improves the resolution of angle estimation.

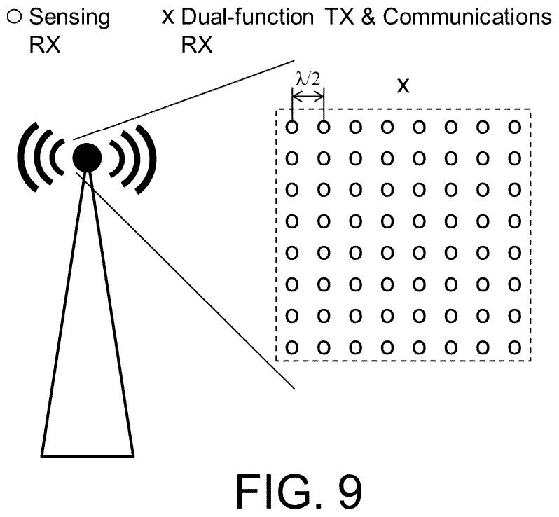

In an embodiment, there is provided another hybrid ISAC transmission and reception scheme with sensing-dedicated receive antenna as shown in FIG. 9.

This embodiment includes a single-antenna system plus 64-antenna array dedicated for sensing. The single-antenna system transmits and receives the communications signal and it also transmits the sensing signal. 64 antennas are used only to receive the sensing signal.

Using this scheme, the communication function is a conventional single-antenna system. The sensing function is a SIMO radar. The sensing-dedicated receive antenna can be omnidirectional or directional.

In an embodiment, the directional sensing receive antenna helps to limit the self-interference send by the transmission antenna. The single antenna transmits the sensing signal and the 64-antenna array receives the echo sensing signal.

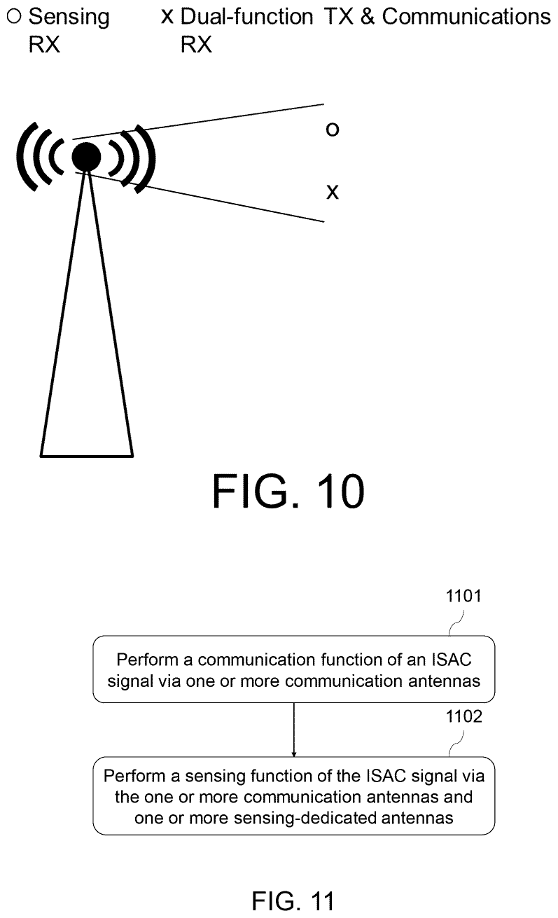

In an embodiment, there is provided another hybrid ISAC transmission and reception scheme with sensing-dedicated receive antenna as shown in FIG. 10.

This embodiment includes a single-antenna system plus a single antenna dedicated for sensing. The single-antenna system transmits and receives the communications signal and it also transmits the sensing signal. The sensing-dedicated antenna is used only to receive the sensing signal.

Using this scheme, the communication function is a conventional single-antenna system. The sensing function is a SISO radar. The sensing-dedicated receive antenna can be omnidirectional or directional.

In an embodiment, the directional sensing receive antenna helps to limit the self-interference sent by the transmission antenna. The dual-function transmission antenna transmits the sensing signal and the sensing dedicated antenna receives the echo sensing signal.

From the perspective of antenna port, the proposed transmission and reception schemes also show a difference to the existing antenna port allocation. The antenna port is defined such that the channel over which a symbol on the antenna port is conveyed can be inferred from the channel over which another symbol on the same antenna port is conveyed

In the presented disclosure, the uplink and downlink communications share the antenna ports, while the sensing signal is transmitted and received via different antenna ports. For BS, the uplink means to receive, while the downlink means to transmit. For UE, the uplink means to transmit, while the downlink means to receive.

In an embodiment, antenna ports for the communication function and sensing function are defined as Table 1. Note that the sensing function uses two dedicated groups of antenna ports for respectively transmitting the sensing signal and receive (echo signal corresponding to) the sensing signal.

TABLE 1
Antenna port allocation of ISAC signal

| | Communications | | Sensing | |
|---|---|---|---|---|
| Antenna port | Uplink | Downlink | Transmit | Receive |
| Starting with 0 | DMRS for | / | | |
| | PUSCH | | | |
| Starting with 1000 | SRS, PUSCH | PDSCH | | |
| Starting with 2000 | PUCCH | PDCCH | | |
| Starting with 3000 | / | CSI-RS | | |
| Starting with 4000 | PRACH (4000) | SS/PBCH | | |
| | | block | | |
| Starting with 5000 | / | PRS | | |
| Starting with 6000 | | | TX signal | |
| Starting with 7000 | | | | Echo |
| | | | | signal |

In an embodiment, antenna ports for the communication function and sensing function are defined as Table 2. In this embodiment, the sensing function uses a dedicated groups of antenna ports for transmitting the sensing signal and reuses communication antenna ports for receiving the (echo signal corresponding to) sensing signal.

TABLE 2
Antenna port allocation of ISAC signal

| | Communications | | Sensing | |
|---|---|---|---|---|
| Antenna port | Uplink | Downlink | Transmit | Receive |
| Starting with 0 | DMRS for | / | | |
| | PUSCH | | | |
| Starting with 1000 | SRS, PUSCH | PDSCH | | Echo |
| | | | | signal |
| Starting with 2000 | PUCCH | PDCCH | | |
| Starting with 3000 | / | CSI-RS | | |
| Starting with 4000 | PRACH (4000) | SS/PBCH | | |
| | | block | | |
| Starting with 5000 | / | PRS | | |
| Starting with 6000 | | | TX signal | |

In an embodiment, antenna ports for the communication function and sensing function are defined as Table 3. In this embodiment, the sensing function reuses communications antenna ports for transmitting the sensing signal and uses a dedicated groups of antenna ports for receiving (echo signal corresponding to) the sensing signal.

TABLE 3
Antenna port allocation of ISAC signal

| | Communications | | Sensing | |
|---|---|---|---|---|
| Antenna port | Uplink | Downlink | Transmit | Receive |
| Starting with 0 | DMRS for | / | | |
| | PUSCH | | | |
| Starting with 1000 | SRS, PUSCH | PDSCH | | |
| Starting with 2000 | PUCCH | PDCCH | | |
| Starting with 3000 | 1 | CSI-RS | | |
| Starting with 4000 | PRACH (4000) | SS/PBCH | | |
| | | block | | |
| Starting with 5000 | / | PRS | TX signal | |
| Starting with 6000 | | | | Echo |
| | | | | signal |

In an embodiment, antenna ports for the communication function and sensing function are defined as Table 4. In this embodiment, the sensing function uses dedicated antenna ports of node A for transmitting the sensing signal and uses the antenna ports of another node B to receive (the echo signal corresponding to) the sensing signal. The antenna ports of node B can be either communications antenna ports or sensing-dedicated antenna ports.

TABLE 4
Antenna port allocation of ISAC signal

| Antenna port of | Communications | | Sensing | |
|---|---|---|---|---|
| Node A | Uplink | Downlink | Transmit | Receive |
| Starting with 0 | DMRS for | | | |
| | PUSCH | | | |
| Starting with 1000 | SRS, PUSCH | PDSCH | | |
| Starting with 2000 | PUCCH | PDCCH | | |
| Starting with 3000 | | CSI-RS | | |
| Starting with 4000 | PRACH (4000) | SS/PBCH | | |
| | | block | | |
| Starting with 5000 | | PRS | | |
| Starting with 6000 | | | TX signal | |
| Antenna Port of | | | | Echo |
| Node B | | | | signal |

In an embodiment, antenna ports for the communication function and sensing function are defined as Table 5. In this embodiment, the sensing function reuses communications antenna ports of a node A for receiving (the echo signal corresponding to) the sensing signal and uses the antenna ports of another node B for transmitting the sensing signal. The antenna ports of the node B can be either communications antenna ports or sensing-dedicated antenna ports.

TABLE 5
Antenna port allocation of ISAC signal

| Antenna port of | Communications | | Sensing | |
|---|---|---|---|---|
| Node A | Uplink | Downlink | Transmit | Receive |
| Starting with 0 | DMRS for | | | |
| | PUSCH | | | |
| Starting with 1000 | SRS, PUSCH | PDSCH | | |
| Starting with 2000 | PUCCH | PDCCH | | |
| Starting with 3000 | / | CSI-RS | | |
| Starting with 4000 | PRACH (4000) | SS/PBCH | | Echo |
| | | block | | signal |
| Starting with 5000 | / | PRS | | |
| Antenna Port of | | | TX signal | |
| Node B | | | | |

FIG. 11 shows a flowchart of a method according to an embodiment of the present disclosure. The method shown in FIG. 11 may be used in a wireless communication and sensing node (e.g., a network node, BS, UE) and comprises the following steps:

Step 1101: Perform a communication function of an ISAC signal via one or more communication antennas.

Step 1102: Perform a sensing function of the ISAC signal via the one or more communication antennas and one or more sensing-dedicated antennas.

In this embodiment, the wireless communication and sensing node performs a communication function of (e.g., associated with, corresponding to) an ISAC signal (e.g., transmitting and/or receiving communication signal in the ISAC signal) via one or more communication antennas. In addition, the wireless communication and sensing node performs a sensing function of (associated with, corresponding to) the ISAC signal (e.g., transmitting and/or receiving a sensing signal in the ISAC signal via one or more communication antennas and one or more sensing-dedicated antennas.

In the present disclosure, for the sensing function, one node transmits the ISAC signal and the same or another node receives the sensing part/signal in the ISAC signal and extracts/determines (sensing) information associated with a sensing target/object from/based on corresponding wireless channel/path information. For the communication function, one node transmits the ISAC signal and another node receives communications part/signal of the ISAC signal and extracts/determines (communication) information (e.g., data) carried on the ISAC signal. As the communications function also needs to obtain the channel information for demodulation, the sensing signal may also be used as a reference signal of the communication signal.

In an embodiment, the communication signal of the ISAC signal is sent and received by the one or more communication antennas and the sensing signal of the ISAC signal is received by the one or more communication antennas and transmitted by the one or more sensing-dedicated antennas.

In an embodiment, the communication signal of the ISAC signal is sent and received by the one or more communication antennas and the sensing signal of the ISAC signal is transmitted by the one or more communication antennas and received by the one or more sensing-dedicated antennas.

In an embodiment, the communication function is half-duplex.

In an embodiment, the sensing function is full-duplex.

In an embodiment, the one or more communication antennas comprises a structure of at least one of a uniform linear array, a uniform two-dimensional array, or an irregular array.

In an embodiment, the one or more sensing-dedicated antennas comprise a structure of at least one of a uniform linear array, a uniform two-dimensional array, or an irregular array.

In an embodiment, the communication function uses at least one of an OFDM waveform or a discrete Fourier transform spread OFDM (DFT-s-OFDM) waveform.

In an embodiment, the sensing function uses at least one of an FMCW signal, an OFDM signal, a pulse signal, a low-correlation sequence signal, or a continuous wave (CW) signal.

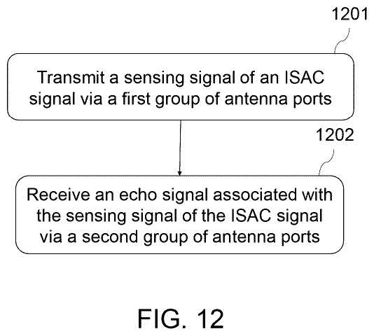

FIG. 12 shows a flowchart of a method according to an embodiment of the present disclosure. The method shown in FIG. 12 may be used in (e.g., performed by) a wireless communication and sensing node (e.g., network node, BS, UE) and comprises the following steps:

Step 1201: Transmit a sensing signal of an ISAC signal via a first group of antenna ports.

Step 1202: Receive an echo signal associated with the sensing signal of the ISAC signal via a second group of antenna ports.

In FIG. 12, the wireless communication and sensing node uses a first group of antenna ports for transmitting a sensing signal of an ISAC and uses a second group of antenna ports for receiving (an echo signal associated with/corresponding to) the sensing signal, wherein the first group of antenna ports is different from the second group of antenna ports. In other words, the wireless communication and sensing node uses different groups of antenna ports for transmitting and receiving the sensing signal.

In an embodiment, the first group of antenna ports and the second group of antenna ports are dedicated for the sensing signal (see Table 1).

In an embodiment, one of the first group of antenna ports and the second group of antenna ports is configured to perform communications associated with the ISAC signal and another one of the first group of antenna ports and the second group of antenna ports is dedicated for the sensing signal (see Tables 2 and 3).

In an embodiment, the first group of antenna ports and the second group of antenna ports belong to (e.g., are corresponding to) single wireless communication and sensing node (see Tables 1 to 3).

For example, an exemplified communication and sensing node in the present disclosure may comprises a communication unit configured to:
transmit a sensing signal of an ISAC signal via a first group of antenna ports, and
receive an echo signal associated with the sensing signal of the ISAC signal via a second group of antenna ports different from the first group of antenna ports.

In an embodiment, one of the first group of the antenna ports and the second group of antenna ports belongs to (e.g., is corresponding to) a first wireless communication and sensing node and another one of the first group of the antenna ports and the second group of antenna ports belongs to (e.g., is corresponding to) a second wireless communication and sensing node different from the first wireless communication and sensing node (see Tables 4 and 5).

For instance, a wireless communication and sensing system of the present disclosure may comprise a first wireless communication and sensing node and a second wireless communication and sensing node. The first wireless communication and sensing node is configured to transmit a sensing signal of an ISAC signal via a first group of antenna ports and the second wireless communication and sensing node is configured to receive (an echo signal associated with/corresponding to) the sensing signal of the ISAC signal via a second group of antenna ports, wherein the first group of antenna ports are different from the second group of antenna ports.

While various embodiments of the present disclosure have been described above, it should be understood that they have been presented by way of example only and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication and sensing method comprising:
performing, by a wireless communication and sensing node, a communication function of an integrated sensing and communication (ISAC) signal via one or more communication antennas; and
performing, by the wireless communication and sensing node, a sensing function of the ISAC signal via the one or more communication antennas and one or more sensing-dedicated antennas.

2. The wireless communication and sensing method of claim 1, wherein a communication signal of the ISAC signal is sent and received by the one or more communication antennas and a sensing signal of the ISAC signal is received by the one or more communication antennas and transmitted by the one or more sensing-dedicated antennas.

3. The wireless communication and sensing method of claim 1, wherein a communication signal of the ISAC signal is sent and received by the one or more communication antennas and a sensing signal of the ISAC signal is transmitted by the one or more communication antennas and received by the one or more sensing-dedicated antennas.

4. The wireless communication and sensing method of claim 1, wherein the communication function is half-duplex; and
wherein the sensing function is full-duplex.

5. The wireless communication and sensing method of claim 1, wherein the one or more communication antennas comprises a structure of at least one of a uniform linear array, a uniform two-dimensional array, or an irregular array.

6. The wireless communication and sensing method of claim 1, wherein the one or more sensing-dedicated antennas comprise a structure of at least one of a uniform linear array, a uniform two-dimensional array, or an irregular array.

7. The wireless communication and sensing method of claim 1, wherein the communication function uses at least one of an orthogonal frequency division Multiplexing (OFDM) waveform or a discrete Fourier transform spread orthogonal frequency division multiplexing (DFT-s-OFDM) waveform.

8. The wireless communication and sensing method of claim 1, wherein the sensing function uses at least one of a frequency modulated continuous wave (FMCW) signal, an OFDM signal, a pulse signal, a low-correlation sequence signal, or a continuous wave (CW) signal.

9. A wireless communication and sensing node comprising:
one or more communication antennas configured to perform a communication function of an integrated sensing and communication (ISAC) signal and a sensing function of the ISAC signal; and
one or more sensing-dedicated antennas configured to perform a sensing function of the ISAC signal.

10. The wireless communication and sensing node of claim 9, wherein the one or more communication antennas are configured to send and receive a communication signal of the ISAC signal, and the one or more sensing-dedicated antennas are configured to receive a sensing signal of the ISAC signal; and
wherein the one or more communication antennas are configured to send and receive a communication signal of the ISAC signal, and the one or more sensing-dedicated antennas are configured to transmit a sensing signal of the ISAC signal.

11. The wireless communication and sensing node of claim 9, wherein the communication function is half-duplex; and
wherein the sensing function is full-duplex.

12. The wireless communication and sensing node of claim 9, wherein the one or more communication antennas comprises a structure of at least one of a uniform linear array, a uniform two-dimensional array, or an irregular array.

13. The wireless communication and sensing node of claim 9, wherein the one or more sensing-dedicated antennas comprise a structure of at least one of a uniform linear array, a uniform two-dimensional array, or an irregular array.

14. The wireless communication and sensing node of claim 9, wherein the communication function uses at least one of an orthogonal frequency division Multiplexing (OFDM) waveform or a discrete Fourier transform spread orthogonal frequency division multiplexing (DFT-s-OFDM) waveform.

15. The wireless communication and sensing node of claim 9, wherein the sensing function uses at least one of a frequency modulated continuous wave (FMCW) signal, an OFDM signal, a pulse signal, a low-correlation sequence signal, or a continuous wave (CM) signal.

16. A wireless communication and sensing method, comprising:
transmitting a sensing signal of an integrated sensing and communication (ISAC) signal via a first group of antenna ports, and
receiving an echo signal associated with the sensing signal of the ISAC signal via a second group of antenna ports,
wherein the first group of antenna ports are different from the second group of antenna ports.

17. The wireless communication and sensing method of claim 16, wherein the first group of antenna ports and the second group of antenna ports are dedicated for the sensing signal.

18. The wireless communication and sensing method of claim 16, wherein one of the first group of antenna ports and the second group of antenna ports is configured to perform communications associated with the ISAC signal and another one of the first group of antenna ports and the second group of antenna ports is dedicated for the sensing signal.

19. The wireless communication and sensing method of claim 16, wherein the first group of antenna ports and the second group of antenna ports are corresponding to a wireless communication and sensing node.

20. The wireless communication and sensing method of claim 16, wherein one of the first group of the antenna ports and the second group of antenna ports is corresponding to a first wireless communication and sensing node and another one of the first group of the antenna ports and the second group of antenna ports is corresponding to a second wireless communication and sensing node different from the first wireless communication and sensing node.
